(19) United States
(12) Patent Application Publication
(10) Pub. No.: US 2005/0130735 A1
(43) Pub. Date: Jun. 16, 2005

(54) Electronic betting card wagering system

(76) Inventor: Peter S. Ellis, Chicago, IL (US)

Correspondence Address: BRINKS HOFER GILSON & LIONE, P.O. BOX 10395, CHICAGO, IL, 60610, US

(21) Appl. No.: 10/732,738

(22) Filed: Dec. 10, 2003

(51) Int. Cl. A63F 13/00

(52) U.S. Cl. 463/25

(57) ABSTRACT

A closed loop totalisator wagering network implements cashless wagering. The wagering network operates with multiple mode electronic betting cards that are accepted in the wagering network and at third party financial networks outside the wagering network. The wagering network frees the patron from the time consuming and error prone administrative drudgery associated with keep track of totalisator tickets and other wagering indicia. Patrons need not expend resources to ensure that a ticket does not get lost or destroyed, or expend resources to redeem a winning ticket either personally or by mail. Patrons may instead enjoy and concentrate on the wagering events, with the knowledge that the wagering system automatically maintains their account balances based on the result of wagering events.

### BACKGROUND

1. Technical Field

The present invention relates to wagering networks employing electronic betting cards. More specifically, this invention relates to a cashless totalisator network including an electronic card based wagering and payment system.

2. Background Information

Rapid advances in consumer electronics technology has given rise to widely popular cashless payment mechanisms, including debit cards and credit cards. The freedom, flexibility, and cost benefits associated with cashless payment mechanisms have fueled their introduction and acceptance into many areas of commerce. In some instances, for example, electronic betting cards are accepted at wagering establishments to directly activate games of chance such as slot machines.

However, in other areas, wagering systems remain a paper based endeavor requiring physical manipulation of currency, tickets, and other wagering related records, accounts or reports. As a result, such wagering systems suffer significant drawbacks including requiring the issuance, redemption, and tracking of tickets and requiring players to keep tickets safe and redeem the tickets. Thus, players often expend resources to ensure that a ticket does not get lost or destroyed and to redeem a winning ticket either personally or by mail, instead of concentrating on the wagering events.

Thus, a need has long existed for addressing the problems noted above and other previously experienced.

### BRIEF SUMMARY

Methods and systems consistent with the present invention provide wholly or partially cashless totalisator wagering. For example, a wagering network may include a processing system that recognizes a multiple mode electronic betting card, a network interface connected to the processing system, and one or more wagering terminals connected to the network interface. Each wagering terminal may include an electronic betting card reader, an input device, and an output device.

The multiple mode electronic betting card may include two modes: a betting card mode and a financial services card mode. The processing system, as part of a closed loop totalisator wagering network, recognizes the electronic betting card for use in its first mode as a betting card in the closed loop wagering network. One or more third party financial networks also recognize and accept the electronic betting card as a financial services card. Nevertheless, the closed loop totalisator wagering network may maintain independence from the third party financial networks. Thus, for example, the closed loop wagering network may credit and debit a patron betting account maintained in the closed loop wagering network without electronically transferring money between the patron betting account and the third party financial institutions.

In one implementation, each wagering terminal includes an electronic betting card reader for reading patron indicia from the multiple mode electronic betting card. In addition, each wagering terminal may include an input device for accepting a totalisator wager and a totalisator event selection. The wagering terminal will then transmit the patron indicia, totalisator wager, and totalisator event selection to the processing system.

The processing system implements totalisator wagering. To that end, the processing system adds the totalisator wager into a wager pool, supplements the wager pool with additional wagers over time, and responsively determines a patron payoff amount based on the wager pool or on a sporting event with odds. When the patron has won a bet, the processing system may then directly credit the patron betting account with the patron payoff amount.

As another example, a wagering method may include recognizing a dual mode electronic betting card operable in a first mode for interaction with a closed loop totalisator wagering network and operable in a second mode with a third party financial network. The method may also read patron identification indicia from the dual mode electronic betting card into the closed loop totalisator wagering network. As noted above, the closed loop wagering network credits and debits a patron betting account maintained in the closed loop totalisator wagering network without electronically transferring money between the patron betting account and the third party financial institution.

In operation, the wagering method proceeds to accept a patron authorization input, authorize use of the electronic betting card by verifying the patron authorization input, and accept a wager and an event selection. The patron wager (as well as wagers for additional patrons) are added into a wager pool for a wagering event corresponding to the event selection. In response to reception of an event result for the wagering event, the method credits the patron betting account linked to the electronic betting card with a patron payoff amount determined in accordance with established totalisator techniques.

### BRIEF DESCRIPTION OF THE DRAWINGS

FIG. 1 illustrates a closed loop totalisator wagering network.

FIG. 2 shows a process for establishing a patron account and issuing a dual mode betting card for use in the network shown in FIG. 1.

FIG. 3 shows a process for funding a patron account maintained in the network shown in FIG. 1.

FIG. 4 shows a process for cashless totalisator wagering that may be employed by the network shown in FIG. 1.

FIG. 5 shows an expanded view of the processing system introduced in FIG. 1.

FIG. 6 shows a block diagram of a multiple mode electronic betting card that may be used in the wagering network shown in FIG. 1.

### DETAILED DESCRIPTION

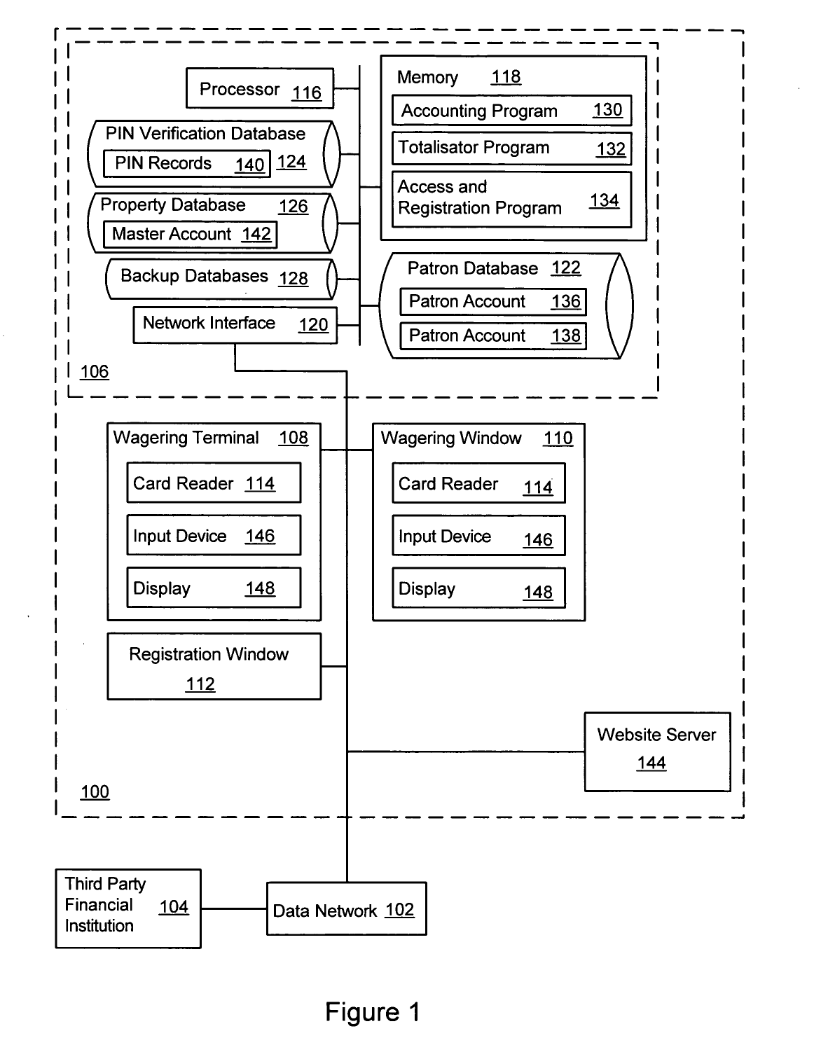

FIG. 1 shows a closed loop totalisator wagering network 100 (“wagering network 100”) in communication over a data network 102 with a third party financial network 104. The wagering network 100 may handle many types of totalisator wagering, including, as examples, horse and dog racing, sportsbook, and lottery wagering. The data network 102 may represent, as examples, the Internet, a proprietary local or wide area network, or another communication network that supports general purpose communication between computer systems. The third party financial network 104 processes general purpose financial transactions. Thus, for example, the financial network 104 may represent a credit card processing company that processes credit card transactions, a traditional bank that processes debit card transactions, a private lending organization, or another financial organization.

The wagering network 100 includes a processing system 106 and one or more wagering terminals 108. In addition, the wagering network 100 includes one or more wagering windows 110 and one or more registration windows 112. The wagering terminals 108, wagering windows 110, and registration windows 112 may include an electronic betting card reader 114, an input device 146, and an output device 148 and may connect to the processing system 106 through network interfaces. The electronic card reader may be a magnetic stripe reader, a radio frequency (RF) card reader, or a smart card reader, as examples. The input device 146 may represent a mouse, keyboard, touchscreen, voice recognition device, or another input mechanism. The output device 148 provides feedback to the patron or to the wagering network employee, and may be implemented as a display, voice output, printer, or another feedback mechanism.

The wagering terminals 108 provide automated patron access to the totalisator wagering functions provided by the wagering network 100. The patron may interact with the wagering terminal 108 to check pending wagering events, place bets, monitor event outcomes, obtain a payout from a betting account, and check account balances, as examples. The wagering windows 110 provide similar access, but may be staffed with wagering network employees who assist the patron with the placing wagers, obtaining payouts, and monitoring wagering events. The registration windows 112 provide a location where a new patron may register and obtain an electronic betting card as explained in more detail below.

The processing system 106 includes a processor 116, a memory 118, and a network interface 120. The processing system 106 may represent a processing system in place at a remote totalisator company, may represent a processing system local to the wagering establishment (e.g., a local to a horse track), or may represent processing systems distributed between the two. The processing system 106 interoperates with several databases. The databases may include a patron database 122, a personal identification number (PIN) database 124, a property database 126, and one or more database backups 128 for those databases.

The memory 118 stores programs that the processor 116 executes. To that end, the memory 118 may include an accounting program 130, a totalisator program 132, and an access and registration program 134. Each will be explained in more detail below.

Before setting forth any additional explanation, however, it is noted that all of the discussion in this document, regardless of the particular implementation being described, is exemplary in nature, rather than limiting. For example, although selected aspects, features, or components of the wagering network are depicted as being stored in the memory 118 and databases 122-128, wagering networks consistent with the present invention may employ a wide range of machine-readable media, for example, secondary storage devices such as hard disks, floppy disks, and CD-ROMs; a signal received from a network; or other forms of ROM or RAM either currently known or later developed.

Furthermore, although specific components of a wagering network 100 will be described, methods, systems, and articles of manufacture consistent with the wagering network may contain additional or different components. For example, the processor 116 may be a microprocessor, microcontroller, application specific integrated circuit (ASIC), discrete logic, or a combination of other types of circuits acting as explained above. Similarly, the memory 118 may be DRAM, SRAM, Flash or any other type of memory. With regard to databases, they may be separately stored and managed, incorporated into a single database, or generally logically and physically organized in many different ways. Furthermore, the databases may more generally represent data files that may be searched using techniques other than relational database queries, for example. The individual programs discussed below may be parts of a single program, separate programs, or distributed across several memories and processors.

The accounting program 130 and totalisator program 132 may be commercially obtained software programs. The accounting program 130 may track and maintain the accounting information for the wagering network 100, including a record of the bets placed, wagering events, payouts, income, operating expenses, and other accounting details, including crediting and debiting the patron accounts as explained in more detail below.

The accounting program 130 and registration program 134 may support such features as adding new accounts, updating accounts, deleting accounts, adding value to an account, performing account balance inquiries, debiting value from an account, and performing account demographic inquiries. In addition, the accounting program 130 may include standard daily, weekly, and monthly reporting functions and may support queries relating to the non-personalized accounts opened and the accounts converted to personalized account, as well as perform account maintenance audits, credit and debit accounts, and determine an amount revolving on an account.

The totalisator program 132 performs processing consistent with totalisator wagering. To that end, the totalisator program 132 may collect and pool wagers from multiple patrons into a single wagering pool and determine patron payoffs based on the pool, odds, and other totalisator wagering characteristics.

The access and registration program 134 establishes new patron accounts and controls access to the patron accounts. As explained in more detail below, the access and registration program 134 may accept and verify authorization information provided by the patron. The program 134 thereby implements access control to the patron account linked to an electronic betting card.

The patron database 122 stores patron betting accounts 136, 138. The patron betting accounts 136, 138 store patron information including name, address, phone number, fund balance, wagering history, electronic betting card number, and other information associated with the patron. The PIN database 124 stores PIN records 140. Each PIN record may include an electronic betting card number and an associated PIN, for example.

The property database 126 stores a master property account record 142. The master account record 142 may store information related to the overall operation of the wagering network 100, including the accounting information maintained by the accounting program 130. As examples, the master account record 142 may store payoff and income totals, patron statistics, event statistics, and other information generally applicable to the operation of the wagering network 100 as a whole.

Note also that the wagering network 100 may also include a website server 144. As a result, a patron may interact with the wagering system 100 through the Internet to place bets, track events, and monitor their account information. The website server 144 provides web pages with player ID, card ID, PIN input, wager selection and input forms through which the patron may participate in wagering events from locations remote from the wagering system 100.

The wagering network 100 is a closed loop network. In other words, the wagering network 100 locally maintains patron accounts without directly transferring money between the patron accounts and the third party financial network 104 (e.g., via automated clearing house (ACH) transfers). The wagering network 100 may communicate with the third party financial network 104 to process standard financial transactions, however. Thus, the patron may pay for goods and services, as examples, through the wagering window 110, including paying for additional funding for their patron account. Because the electronic betting card is a dual mode card, the patron may also employ the betting card outside of the wagering network 100 wherever PIN based electric card transactions are supported.

In one implementation, the electronic betting card used with the wagering network 100 includes a card number, but does not store the account balance. Rather, the wagering network 100 itself maintains the patron account balance as part of the patron betting account 136. In that regard, the wagering network 100 credits, debits, and otherwise maintains the patron betting account 136 so that the patron may obtain their funds directly form the wagering network 100. The patron betting account 136 is thereby separate from a traditional bank account.

The electronic betting cards used in the wagering network 100 are multiple mode electronic betting cards. In one implementation, the multiple mode electronic betting cards are dual mode cards. A first mode provides patron account information specific to the wagering network 100 that is recognized and accepted by the wagering network 100. For example, the patron account information may include a patron name, an electronic betting card number, and an ID tag recognized by the wagering network 100. A second mode provides customer information in a format specified by the third party financial network 104. For that reason, the dual mode card operates in both the wagering network 100 and in the financial network 104, although, as noted above, the wagering network 100 is a closed loop network.

The electronic betting cards may be implemented in many ways. For examples, the betting card may include a magnetic stripe that bears information for both modes of use. As another example, the betting card may be a smart card that includes a re-writeable memory that stores the mode information.

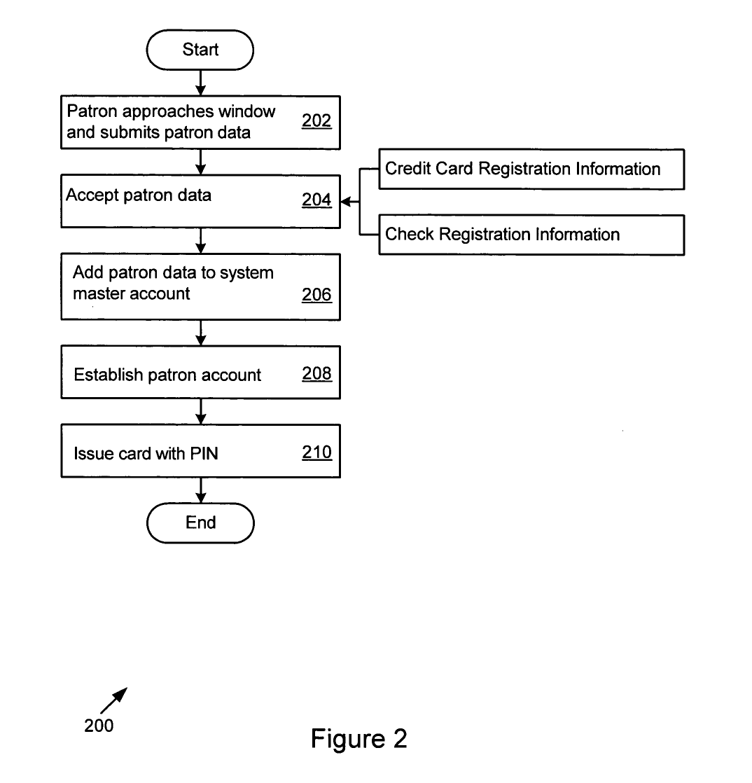

Turning to FIG. 2, that figure shows a process 200 that the registration program 134 may employ to establish a patron account and issue a dual mode betting card for use in the wagering network 100 shown in FIG. 1. Initially, a patron approaches the registration window 112 and submits patron data (Step 202). The patron data may include, as examples, patron name, address, phone number, and preferred PIN number. As shown in FIG. 2, the patron may also provide debit card information, credit card information (e.g., name, credit card number, and expiration date) or personal check registration information (e.g., patron name, bank name, account number, routing numbers, and other account and bank indicia).

The registration program 134 accepts the patron data (Step 204) communicated over the network interface 120. In response, the registration program 134 adds the patron data to the master account 142 (Step 206). In addition, the registration program 134 creates a new patron account 136 in the patron database 122 (Step 208). The new patron account 136 maintains the patron wagering account balance for the patron. The registration program 134 may also select and record a new electronic betting card number for the patron.

When the registration program 134 has successfully established the new patron account, the registration program 134 generally sends back a success indicator and the new electronic betting card number to the registration window 112. In response, the employee (or an automated card dispenser) at the registration window 112 issues a new electronic betting card to the patron (Step 210). To that end, the employee may swipe the electronic betting card through a magnetic stripe reader/recorder to encode the patron data and the betting card number on the new electronic betting card.

Note that patrons may be issued a non-personalized card or apply for a personalized card. The non-personalized card may be obtained by submitting money to fund an account, without providing personal information such as name, phone number or credit card information. As a result, a new patron may quickly experience totalisator wagering, without spending time to fully register. Subsequently, when a personalized card application is approved, an electronic betting card is created and provided to the cardholder to replace the non-personalized card.

The patron may register with the wagering network 100 in other ways, however. For example, the patron may complete an application and present the application to a customer service person for processing. The customer service person may then require a signature capture or identification scan of customer credit cards or a check, as examples, to complete application. Alternatively, the patron may complete an application served by the wagering network intranet at onsite PC stations. The PC station may similarly obtain a signature capture or scan identification documents. As yet another alternative, the patron may complete an Internet application provided by the website server 144. The wagering network 100 may then request an in-person follow up for signature capture or scanning of identification documents.

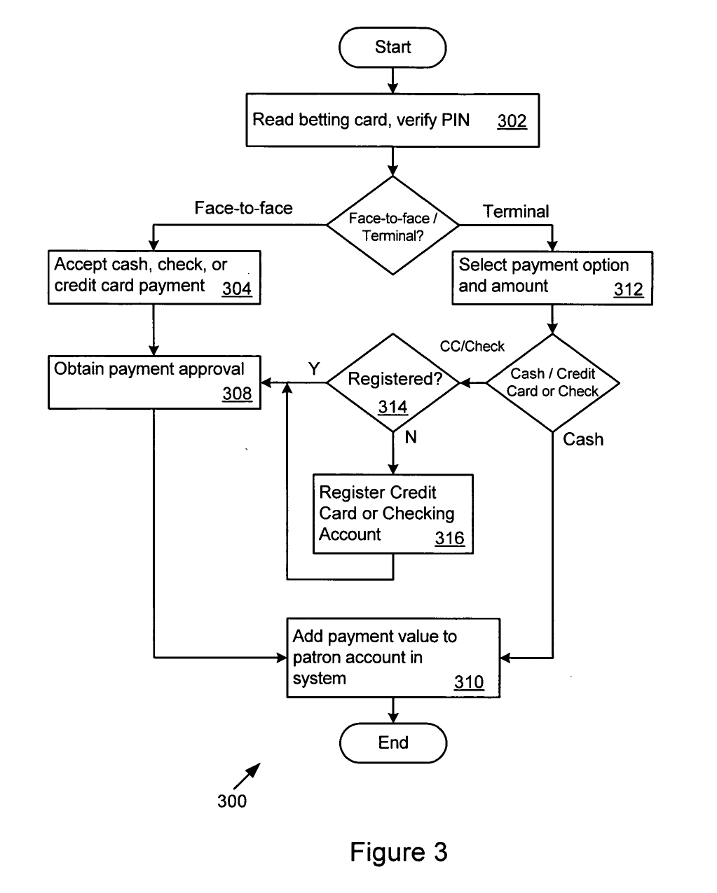

With regard next to FIG. 3, that Figure shows a process 300 that the registration program 134 and the accounting program 130 may employ to fund a patron account maintained in the wagering network 100. An electronic card reader first reads the card number from the electronic betting card and the registration program 134 verifies an entered PIN number against the PIN verification database 124 (Step 302). For a face-to-face transaction (e.g., at the wagering window 110 or registration window 112), cash, check, or credit card payment is accepted from the patron (Step 304). The wagering network 100 then obtains a corresponding payment approval (Step 308). In response to an approved payment, the accounting program 130 adds the payment value to the locally maintained patron wagering account 136 (Step 310).

When the patron is interacting with an automated wagering terminal 108, the patron may instead use the input device 146 to select a payment option and a payment amount (Step 312). When cash is selected, the patron inserts currency into an automated bill acceptor (for example). In response to currency validation, the accounting program 130 adds the payment value to the patron account 136 (Step 310).

On the other hand, when the patron uses a credit card or their checking account to add value to their patron account, the registration program 134 checks whether the credit card or the checking account is registered with the wagering system 100 (Step 314). To that end, the registration program 134 may compare the submitted credit card or checking account information against the patron data present in the patron account 136 or in the master account 142. If the credit card or checking account is not registered, the registration program 134 may register the credit card information or checking account information as noted above with regard to FIG. 2 (Step 316). Once the credit card or checking account payment is approved (Step 308), the accounting program 130 may then add value to the patron account 136 (Step 310).

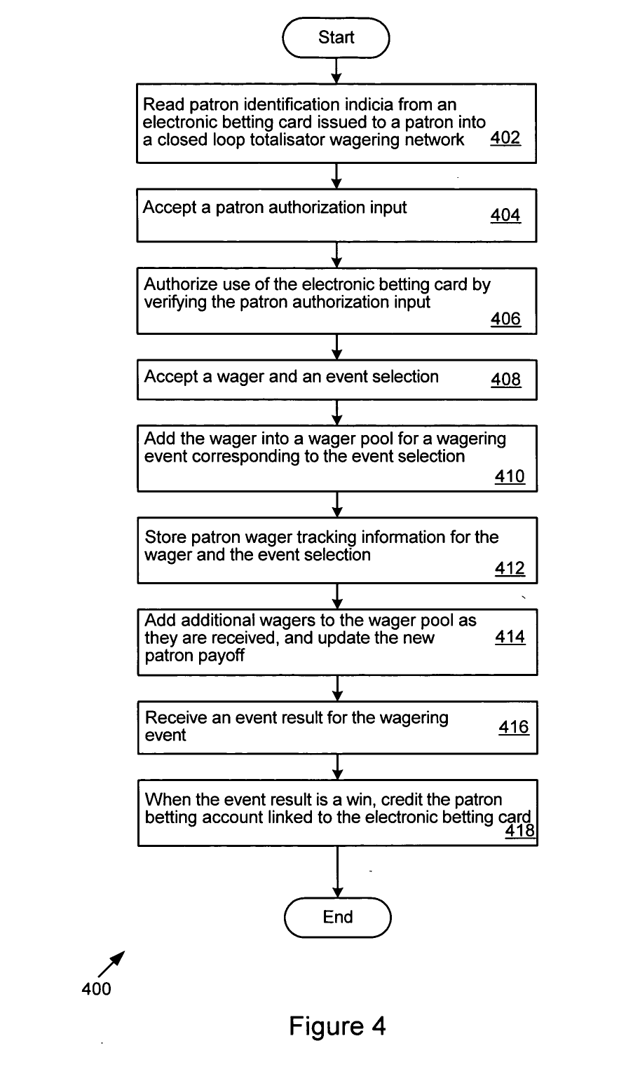

FIG. 4 shows a process 400 for cashless totalisator wagering that the wagering network 100 may employ. The closed loop wagering network 100 reads patron identification indicia from a multiple mode electronic betting card (Step 402). The identification indicia may include an electronic betting card number, a patron name or other information. Next, the wagering network 100 accepts a patron authorization input (Step 404). For example, the wagering network 100 may accept a patron PIN input.

In response, the wagering network 100 authorizes use of the electronic betting card by verifying the patron authorization input (Step 406). Once authorized, the wagering network 100 may accept an event selection, for example a horse race selection, and a patron wager, for example, a $100.00 bet on a first place finish for a selected horse (Step 408).

In keeping with established totalisator wagering, the totalisator program 132 adds the patron wager amount into a wager pool for the wagering event (Step 410). In addition, the wagering network 100 stores patron wagering tracking information, for example in the master account 142, or another database (Step 412). The patron wagering tracking information may include patron name, event selection, patron wager, a patron account identifier, and the patron electronic betting card number, as examples.

Note that the electronic betting card may be employed for many purposes in the wagering network 100. In addition to placing a wager, the patron may also employ the betting card to purchase concessions or purchase entry into a track or gaming campus, as examples.

As additional wagers are received, the totalisator program 132 adds them to the wager pool for the appropriate event (Step 414). The totalisator program 132 may also update odds, payoff amounts, and other totalisator statistics. After the event has completed, the wagering network 100 receives an event result (Step 416). In response, the totalisator program 132 may calculate a patron payoff and communicate the patron payoff to the accounting program 130. In response, the accounting program 130 may then credit the patron account 136 with the payoff amount.

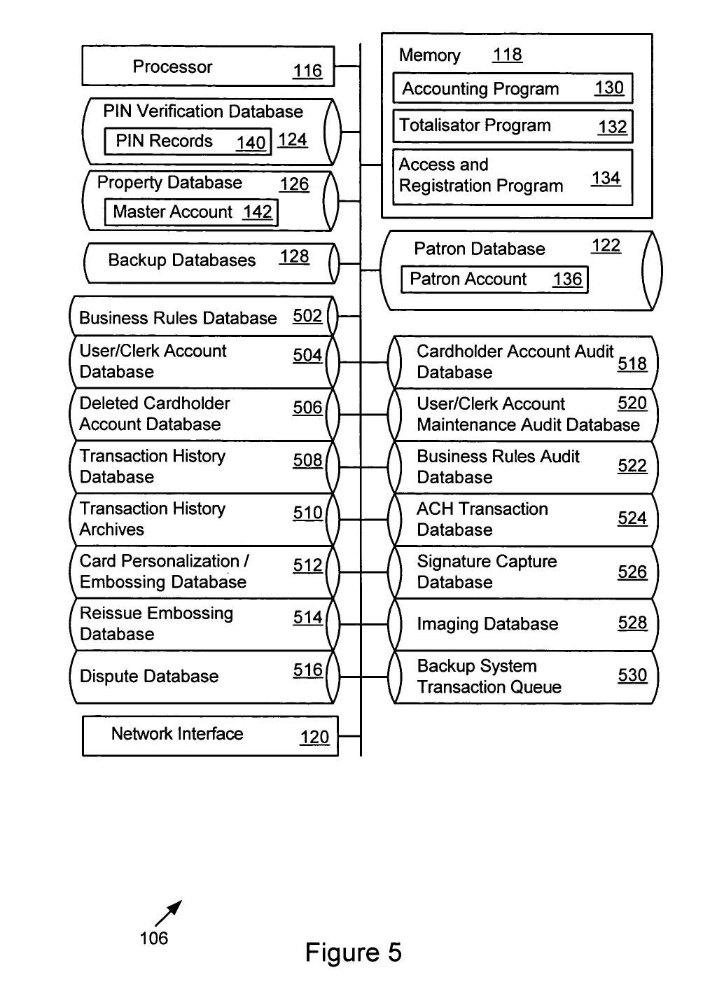

Turning next to FIG. 5, that Figure shows an expanded view of the processing system 106. More specifically, the processing system 106 includes support databases including a Business Rules Database 502, a User/Clerk Account Database 504, a Cardholder Account Database 504, a Deleted Cardholder Account Database 506, a Transaction History Database 508, and a Transaction History Archive 510. In addition, the processing system 106 includes a Card Personalization/Embossing Database 512, a Reissue Embossing Database 514, and a Dispute Database 516. The processing system 106 may also include a Cardholder Account Audit Database 518, a User/Clerk Account Maintenance Audit Database 520, a Business Rules Audit Database 522, and an ACH Transaction Database 524. The following databases may also be present: a Signature Capture Database 526, an Imaging Database 528, and a Backup System Transaction Queue 530.

The business rules database 502 may store a rule set that governs the operation of the wagering network 100. As a default, all rules will be applied on installation of wagering network 100, and employees with appropriate access can update the Business Rules to any of the system defined available options.

The user/clerk account database 504 stores employee information for employees of the wagering network 100. The account database 504 thereby supports adding new users, updating existing user access, and deleting existing users.

The deleted cardholder account database 506 stores the records of patrons who have terminated their accounts. The transaction history database 508 stores records with transaction details relating to account debits, credits, deletions, and other administrative actions. The transaction history archives 510 stores records from the transaction history database 508 that are older than a pre-selected threshold.

The card personalization and embossing database 512 stores information on the electronic betting cards issued to patrons, including patron name, card number, and other card characteristics. A file transfer protocol (FTP) process may be employed to transfer records from the embossing database 512 to a vendor for card creation and mailing.

The reissue embossing database supports a monthly (or other time period) audit of card expiration dates that are 60 days out. The wagering system 100 thus processes the business rules against the cardholder account to see if it qualifies for reissue. If approved for reissue, the wagering system 100 updates the cardholder account expiration date with a new date and creates a reissue embossing record for the cardholder account.

The dispute database 516 logs and monitors cardholder claims. Thus, when a patron claims that the wagering system did not perform a transaction, an appropriate record is established in the dispute database 516.

The cardholder account audit database 518 stores audit records arising from checks, verifications, and changes to selected patron accounts. The user/clerk account maintenance audit database 520 stores audit records arising from checks, verifications, and changes to selected employee accounts. The business rules audit data base 522 stores audit records arising from checks, verifications, and changes to the business rules database 502.

The ACH transaction database 524 may be implemented for future capability expansion of the wagering network 100. The ACH transaction database 524 stores ACH records relating to the transfer of money into the wagering system 100 to a cardholder account from a predefined bank account, and also relating to transfer of money out of the track to a predefined bank account from a cardholder account.

The signature capture database 526 stores records of graphical data that represent images of a patron signature or other verification data. The imaging database 528 stores records of graphical data that represents images of a patron, patron identification, or other patron indicia. The backup system transaction queue 530 stores backup transaction entries awaiting processing for backing up any of the data in the wagering network 100.

Note also that the wagering network 100 supports additional functionality. Thus, as one example, the wagering network 100 includes lost/stolen card functionality. When a patron reports an electronic betting card lost or stolen, the wagering network 100 responsively updates an account status to ‘lost/stolen’, updates a remote totalisator system with the card status if necessary, opens a new account, and performs an account transfer from the old account to the new account. Risk management features may include business rules for reporting and managing risk, including the maximum number of deposits in one day, the maximum dollar amount in a single deposit, the maximum deposit met a pre-selected number of days in succession, and a maximum amount deposited, less than a pre-selected number of transactions, coupled with the betting card cashed to zero on the same day or within a pre-selected number of days.

The wagering network 100 may further provide a redundant cardholder account, including a “hot or live” backup system. In this regard, the wagering network 100 may update all patron transactions on both a primary and a backup system simultaneously. Then, if the primary system should fail, the wagering network 100 may automatically switch to the backup system for processing ‘add value’ and payment transactions. The transactions made on backup system may be queued in the transaction queue 530 for updating the primary system when restored.

A wagering system 100 backup and restore process may also execute. The process may perform a nightly backup of the wagering system 100 to a machine readable medium for offsite storage. The restore process may then restore the system from the last backup when necessary.

Processes executed nightly may include processing for card personalization and embossing, any pre-defined standard daily financial and statistical reporting, accounting and settlement, and ACH processing. Processes executed weekly may include processing and pre-defined standard weekly reporting, and transmit the week's accumulation of card personalization and embossing records to a vendor for electronic betting card creation and mailing. Processes executed monthly may include standard monthly reporting, inactive account processing and reporting, after a business rules defined number of days, move deleted cardholder accounts 136 off the patron database 122 to the deleted accounts database 506, after a business rules defined number of years, permanently delete expired deleted accounts from deleted accounts database 506, automatically reissue a betting card, based on its expiration date and creation of embossing file, and responsively transmit the embossing file to a vendor for creation and mailing.

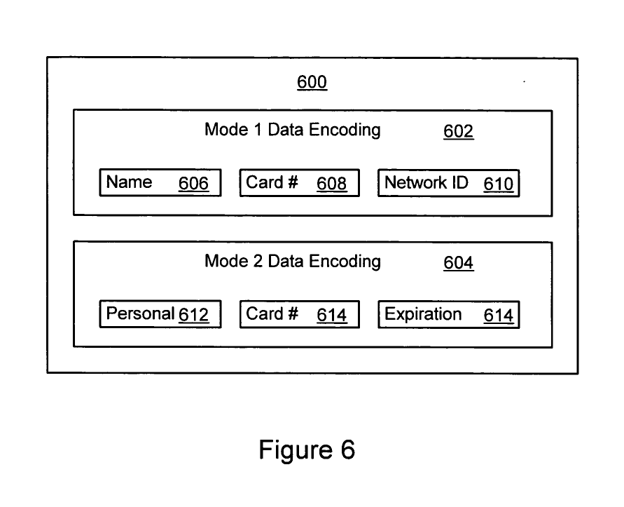

FIG. 6 shows one example of a multiple mode electronic betting card 600 that may be used in the wagering network 100. The card 600 includes mode 1 data encoding 602 and mode 2 data encoding 604. The mode 1 data encoding 602 may be configured with data setup for the wagering network 100. As examples, the mode 1 data encoding 602 may include a patron name 606, a card number 608, and a network ID tag 610 that identifies the mode 1 encoding 602 as data for the wagering network 100.

The mode 2 encoding data 604 includes data specified by the third party financial network 104. The mode 2 encoding data 604 may therefore include standard credit card or debit card information. As examples, the mode 2 encoding data 604 may include a cardholder name 612, a card number 614, and an expiration date 616.

The encoding data 602 and 604 may be stored on a magnetic stripe on the card 600. As another example, a non-volatile memory in the card 600 may store the encoding data 602 and 604. Note that even though the encoding data 602 and 604 may have similar fields (e.g., the card number field), the fields need not have the same contents. Thus, for example, the card number for the purposes of the wagering network 100 may be different than the card number for purposes of the third party financial network 104.

The totalisator wagering network 100 described above implements cashless wagering. As a result, the wagering network 100 frees the patron from the time consuming and error prone administrative drudgery associated with keep track of totalisator tickets and other wagering indicia. The wagering network 100 has reduced operational overhead and does not suffer from the drawbacks of issuing, redeeming, and tracking tickets. For that reason, patrons need not expend resources to ensure that a ticket does not get lost or destroyed, or expend resources to redeem a winning ticket either personally or by mail. Patrons may instead enjoy and concentrate on the wagering events, with the knowledge that the wagering system 100 properly maintains their accounts without their intervention.

Through the use of the dual mode electronic betting card, the wagering system 100 provides gaming operators with a secure tool for wagering remittance. The operators and patrons are no longer limited by the issuance and submission of physical tickets and paper receipts, or mail submission of winning tickets. In addition, the wagering system safely maintains patron winnings in a PIN protected account, thereby eliminating the need for the patron to carry large sums of cash. The dual mode betting card also allows the patron to participate in self service wagering, thereby eliminating lengthy lines at betting establishments and providing an efficient mechanism that allows patrons to submit their wagers to the wagering establishment before an event starts. As a result, gaming operators may also benefit from reduced overhead, for example in the form of reduced staffing requirements.

It is therefore intended that the foregoing detailed description be regarded as illustrative rather than limiting, and that it be understood that it is the following claims, including all equivalents, that are intended to define the spirit and scope of this invention.

1. A method for cashless totalisator wagering comprising:
recognizing a dual mode electronic betting card operable in a first mode for interaction with a closed loop totalisator wagering network and operable in a second mode with a third party financial network;
reading patron identification indicia from the dual mode electronic betting card into the closed loop totalisator wagering network;
crediting and debiting a patron betting account maintained in the closed loop totalisator wagering network without electronically transferring money between the patron betting account and the third party financial institution;
accepting a patron authorization input;
authorizing use of the electronic betting card by verifying the patron authorization input;
accepting a wager and an event selection;
adding the wager into a wager pool for a wagering event corresponding to the event selection;
storing patron wager tracking information for the wager and the event selection;
as additional wagers are received, adding the additional wagers to the wager pool and responsively calculating a patron payoff;
receiving an event result for the wagering event;
when the event result is a win, crediting the patron betting account linked to the electronic betting card with the patron payoff.

2. The method of claim 1, further comprising:
accepting patron personal financial instrument information comprising at least one of credit card and checking account information, and interacting with the patron for at least one of self service, Internet, or telephone wagering.

3. The method of claim 1, where the step of reading patron identification indicia comprises reading patron identification indicia at a wagering window.

4. The method of claim 1, further comprising:
accepting patron personal data at a registration window;
adding the patron personal data to a master account; and
establishing the patron betting account.

5. The method of claim 4, further comprising obtaining an electronic betting card number and storing the electronic betting card identifier in the patron betting account.

6. The method of claim 1, further comprising:
accepting a patron betting card account inquiry at a wagering terminal; and
responding to the patron betting card account inquiry with information obtained from the patron betting account.

7. The method of claim 1, where the step of reading patron identification indicia comprises reading patron identification indicia at a wagering terminal.

8. The method of claim 1, further comprising the step of debiting the patron betting account linked to the electronic betting card when the wager is accepted.

9. A cashless totalisator wagering system comprising:
an electronic betting card reader that recognizes a dual mode electronic betting card operable in a first mode for interaction with a closed loop totalisator wagering network coupled to the card reader and operable in a second mode with a third party financial network and that reads patron identification indicia from the dual mode electronic betting card;
a patron database comprising a patron betting account linked to the electronic betting card through an electronic betting card number;
a memory comprising:
an access program that accepts a patron authorization and verifies the patron authorization input against the patron database;
a totalisator program that accepts a wager and an event selection and that adds the wager into a wager pool for a wagering event corresponding to the event selection, and as additional wagers are received, adds the additional wagers to the wager pool; and
an accounting program that, in response to an event result for the wagering event, credits the patron betting account linked to the electronic betting card with a pari-mutuel payoff for the patron, the accounting program further operable to credit and debit the patron betting account without electronically transferring money between the patron betting account and the third party financial network; and
a processor for executing the access program, totalisator program, and accounting program.

10. The cashless totalisator wagering system of claim 9 further comprising a plurality of wagering terminals in the closed loop totalisator wagering network.

11. The cashless totalisator wagering system of claim 9, where the totalisator program accepts the wager from at least one of a wagering window and a self service interface, the self-self interface comprising at least one of a wagering terminal, Internet website, or telephone wager.

12. The cashless totalisator wagering system of claim 9, where the patron betting account comprises an electronic betting card number and an account balance.

13. The cashless totalisator wagering system of claim 9, further comprising an electronic betting card validation database.

14. The cashless totalisator wagering system of claim 13, where the electronic betting card validation database comprises a personal identification number (PIN) database.

15. The cashless totalisator wagering system of claim 9, further comprising a backup patron database.

16. A cashless totalisator wagering system comprising:
a processing system capable of recognizing a dual mode electronic betting card in a first mode for interaction with a closed loop totalisator wagering network, where the electronic betting card also is operable in a second mode with a third party financial network, where the closed loop totalisator wagering network credits and debits a patron betting account maintained in the closed loop totalisator wagering network without electronically transferring money between the patron betting account and third party financial institutions;
a network interface connected to the processing system;
a plurality of wagering terminals connected to the network interface, each wagering terminal comprising:
an electronic betting card reader for reading patron indicia from the dual mode electronic billing card; and
an input device for accepting a totalisator wager and an totalisator event selection, where the patron indicia, totalisator wager, and totalisator event selection are subsequently transmitted to the processing system,
the processing system further operable to add the totalisator wager into a wager pool, supplement the wager pool with additional wagers over time, and responsively determine a patron payoff amount based on the wager pool in order to credit the patron betting account with the patron payoff amount.

17. The cashless totalisator wagering system of claim 16, where the processing system comprises an electronic betting card validation database.

18. The cashless totalisator wagering system of claim 16, where the processing system comprises an accounting program operable to respond to patron betting account inquiries.

19. The cashless totalisator wagering system of claim 16, where the patron betting account includes an electronic better card identifier.

20. The cashless totalisator wagering system of claim 16, where the processing system is further operable to accept the totalisator wager from at least one of a wagering window and a self service interface, the self-self interface comprising at least one of a wagering terminal, Internet website, or telephone wager.
